(19) United States
(12) Patent Application Publication
(10) Pub. No.: US 2019/0383096 A1
(43) Pub. Date: Dec. 19, 2019

(54) WINDOW CAPABLE OF MOSQUITO PROOF AND AIR PURIFICATION

(71) Applicant: DONGGUAN UNIVERSITY OF TECHNOLOGY, Dongguan (CN)

(72) Inventors: Jun Deng, Dongguan (CN); Xiaowei Liu, Dongguan (CN)

(21) Appl. No.: 16/286,046

(22) Filed: Feb. 26, 2019

(30) Foreign Application Priority Data
Jun. 13, 2018 (CN) CN2018106077096
Dec. 26, 2018 (JP) JP2018-243744

(51) Int. Cl. E06B 9/52; B01D 46/00

(52) U.S. Cl. CPC E06B 9/52; E06B 2009/524; E05Y 2900/148; B01D 46/0005

(57) ABSTRACT

The present invention relates to a window capable of mosquito-proof and air purification, including a mounting slot and a side plate embedded in the wall; and two horizontally movable mounting fixtures are disposed in the middle of each of the upper and lower mounting slots. A purification plate is installed between two mounting fixtures, and glass plate movable devices are installed between each mounting fixture and the slot wall of the mounting slot. A glass plate is installed between the upper and lower glass plate movable devices; the purification plate includes a purification mounting frame installed in between the two mounting fixtures. An aerographite plate is installed in the purification installation frame. The thickness of the aerographite plate is greater than spacing between outer sides of the two mounting fixtures, wherein in the side plates, side slots cooperating with the purification mounting frame are provided. The present invention replaces the existing gauze window structure with a purification plate comprising aerographite plates and purification mounting frames. Good absorption and recovery ability of the aerographite plate combining with the pressing of the glass plate realizes continuous and repeated air purification, and mosquito-proof effect of the gauze window.

### FIELD OF THE INVENTION

The invention relates to the field of window structures, and more particularly to a window that is mosquito-proof and yet provides air purification.

### BACKGROUND OF THE INVENTION

Windows are an indispensable structure in the field of architecture, and most houses have window structures. The type of existing windows is roughly divided into a vertically hinged one and sliding one, and most sliding windows are equipped with gauze for mosquito-proof.

With the degradation of air quality, most houses are equipped with air purification devices to improve the indoor air quality. However, most of the air purification devices are not compatible with the gauze window structures. The function of the above two cannot be promised simultaneously; mosquito-proof, enjoying the natural wind and ensuring the quality of the air cannot be achieved at the same time.

### SUMMARY OF THE INVENTION

The objective of the present invention is to provide a window capable of mosquito-proof and air purification, replacing the existing gauze window structure with a purification plate comprising a purification mounting frame and an aerographite plate. The super-absorption and super-recovery ability of the aerographite plate combining with the pressing of the glass plate realizes continuous and repeated air purification, and the mosquito-proof effect of the gauze window.

In order to achieve the above object, the technical solutions adopted by the present invention are:
a window capable of mosquito-proof and air purification, including a mounting slot and a side plate embedded in the wall; and two horizontally movable mounting fixtures are disposed in the middle of each of the upper and lower mounting slots. A purification plate is installed between two mounting fixtures, and glass plate movable devices are installed between each mounting fixture and the slot wall of the mounting slot. A glass plate is installed between the upper and lower glass plate movable devices; the purification plate includes a purification mounting frame installed in between the two mounting fixtures. An aerographite plate is installed in the purification installation frame. The thickness of the aerographite plate is greater than spacing between outer sides of the two mounting fixtures, wherein in the side plates, side slots cooperating with the purification mounting frame are provided.

Further, a horizontal bottom grid is set in the lower mounting slot. The purification mounting frame and the lower glass plate movable device are mounted on the bottom grid, and at the lower side of the rear plate of the lower mounting slot is provided a drainage opening.

Further, the glass plate movable device includes a glass plate turning mounting seat, which is connected with the glass plate and extends beyond the wall of the mounting slot. A glass plate turning motor is disposed under the glass plate turning mounting seat, and rolling balls are set under and to the sides of the said glass plate turning motor.

Further, the wall of the mounting slot is provided with a soft sealing block for glass plate mounting seat cooperating with the glass plate turning mounting seat.

Further, the sides of glass plates near the aerographite plates are outwardly beveling flats, the outer edges of which are flush with the sides of the aerographite plates, inclining angle between the beveling flats and that of the straight one is 5-20 degrees.

Further, both the left side and right side of the glass plate turning motor are connected to the turning motor movable supporting blocks via the turning motor supporting rods. To the lower part and the sides of the turning motor movable supporting block are provided rolling balls; the upper part of the turning motor movable supporting block works together with the glass plate turning mounting seat by contacts but not connection. And the upper part of the turning motor movable supporting block is a smooth plane.

Further, the mounting frame movable blocks are provided on the upper and lower part of the purification mounting frame. The lower part and the side of the mounting frame movable block are provided with rolling balls.

The beneficial effects of the present invention are:

The existing gauze window structure is replaced by a purification plate composed of a purification mounting frame and an aerographite plate. The super-adsorption and super-recovery ability of the aerographite plate cooperating with the pressing of the glass plate realize continuous and repeated air purification, thereby the mosquito-proof effect of the gauze window is achieved, and the field of vision is wider.

The bottom grid and drainage opening are designed to discharge the squeezed water and contaminants adsorbed on the aerographite plate quickly to prevent them from corroding the glass plate movable device.

The glass plate movable device is simple in structure and convenient in operation, which may realize the push of the glass plate while enabling it to rotate within a certain degree, thereby it is possible to adjust the extent that the aerographite plate is pressed.

The design of soft sealing block for glass plate mounting seat, enables rotation of the glass plate within a certain degree and ensures sufficient sealing of the mounting seat during rotation.

The outwardly beveling flat design of the glass plate sides, plays a guiding role when glass plate contacts the aerographite plate in the first place, meanwhile, the surface inclining is helpful in facilitating rotation of the glass plate by keeping contact surface with the aerographite plate a flat surface even when pressing harder, and avoids hurting the aerographite plate.

The turning motor supporting rods and the turning motor supporting blocks are designed to ensure smooth running of the glass plate during rotation and movement, eliminating possible shaking.

The purification mounting frame movable block is designed to cooperate with the rolling ball, easing movement and limiting the position of the aerographite plate, and thereby ensure the smooth movement of the aerographite plate.

### BRIEF DESCRIPTION OF THE DRAWINGS

FIG. 1 is a front view of a window for mosquito-proof and purification;

FIG. 2 is a cross-sectional view taken along line A-A of FIG. 1;

FIG. 3 is a partial enlarged view of B in FIG. 2;

FIG. 4 is a cross-sectional view taken along line C-C of FIG. 2;

FIG. 5 is a partial enlarged view of D in FIG. 4; and

FIG. 6 is a cross-sectional view taken along line E-E of FIG. 5.

### DETAILED DESCRIPTION OF THE ILLUSTRATED EMBODIMENTS

The drawings include the following integers:

1. Mounting slot;

2. Side plate;

3. Glass plate;

4. Aerographite plate;

5. Mounting fixture;

6. Purification mounting frame;

7. Matching side slot for mounting frame;

8. Bottom grid;

9. Mounting frame movable block;

10. Rolling ball;

11. Glass plate turning motor;

12. Glass plate turning mounting seat;

13. Soft sealing block for glass plate mounting seat;

14. Drainage opening;

15. Turning motor supporting rod;

16. Turning motor movable supporting block.

In order to make those skilled in the art understand the technical solutions of the present invention better, the present invention will be described in detail below with reference to the accompanying drawings, and the description of the present invention is only exemplary and explanatory, should not be construed as limiting the scope of the present invention.

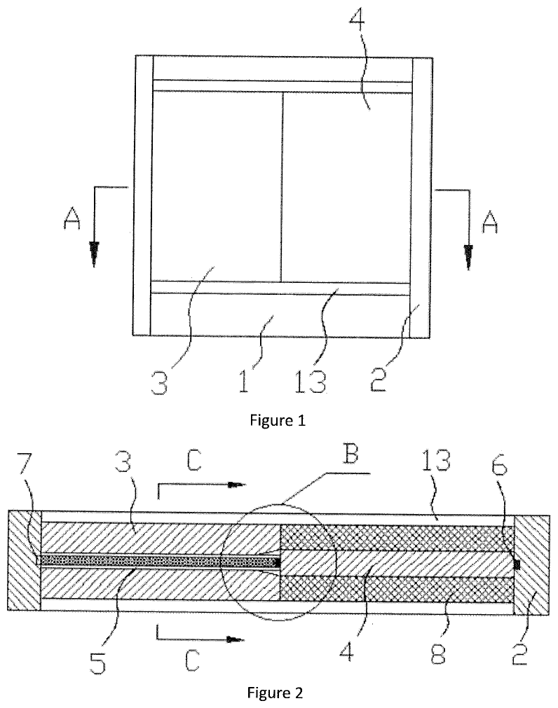

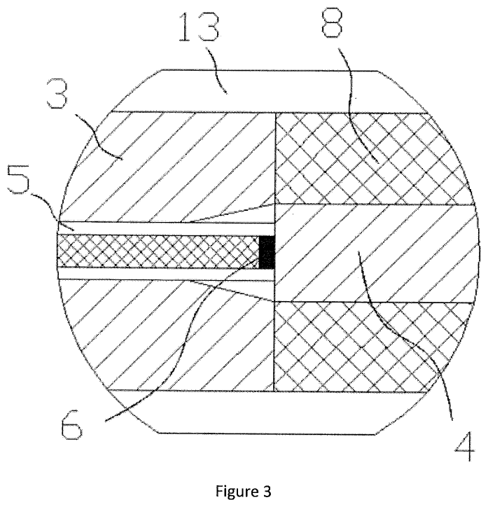

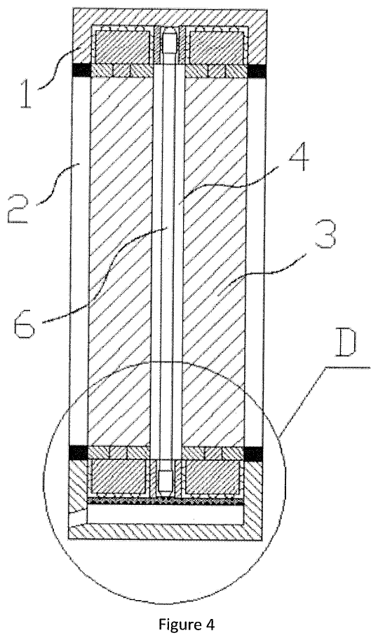

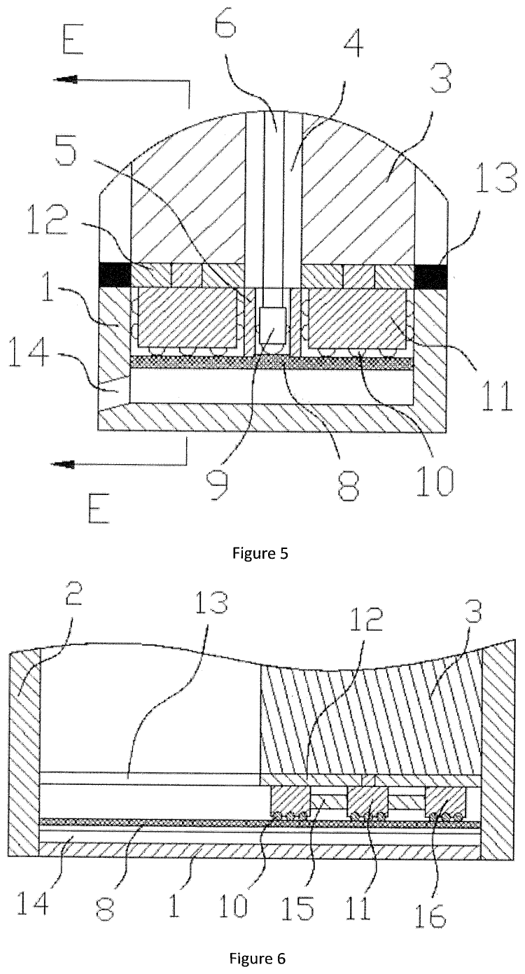

As is shown in FIGS. 1 to 6, the specific structure of the present invention comprises a window capable of mosquito-proof and air purification, including a mounting slot 1 and a side plate 2 embedded in the wall; and two horizontally movable mounting fixtures 5 are disposed in the middle of each of the upper and lower mounting slots 1. A purification plate is installed between two mounting fixtures 5, and glass plate movable devices are installed between each mounting fixture 5 and the slot wall of the mounting slot 1. A glass plate 3 is installed between the upper and lower glass plate movable devices; the purification plate includes a purification mounting frame 6 installed in between the two mounting fixtures 5. An aerographite plate 4 is installed in the purification installation frame 6. The thickness of the aerographite plate 4 is greater than spacing between outer sides of the two mounting fixtures 5, wherein in the side plates 2, side slots 7 cooperating with the purification mounting frame are provided.

Preferably, a horizontal bottom grid 8 is set in the lower mounting slot 1. The purification mounting frame 6 and the lower glass plate movable device are mounted on the bottom grid 8, and at the lower side of the rear plate of the lower mounting slot 1 is provided a drainage opening 14.

Preferably, the glass plate movable device includes a glass plate turning mounting seat 12, which is connected with the glass plate 3 and extends beyond the wall of the mounting slot 1. A glass plate turning motor 11 is disposed under the glass plate turning mounting seat 12, and rolling balls 10 are set under and to the sides of the said glass plate turning motor 11.

Preferably, the wall of the mounting slot 1 is provided with a soft sealing block for glass plate mounting seat 13 cooperating with the glass plate turning mounting seat 12.

Preferably, the sides of glass plates near the aerographite plates 4 are outwardly beveling flats, the outer edges of which are flush with the sides of the aerographite plates 4, inclining angle between the beveling flats and that of the straight one is 5-20 degrees.

Preferably, both the left side and right side of the glass plate turning motor 11 are connected to the turning motor movable supportinging blocks 16 via the turning motor supporting rods 15. To the lower part and the sides of the turning motor movable supporting block 16 are provided rolling balls 10; the upper part of the turning motor movable supporting block 16 works together with the glass plate turning mounting seat 12 by contacts but not connection. And the upper part of the turning motor movable supporting block 16 is a smooth plane.

Preferably, the mounting frame movable blocks 9 are provided on the upper and lower part of the purification mounting frame 6. The lower part and the side of the mounting frame movable block 9 are provided with rolling balls 10. When in use, mount the window first. When the window is closed, the rear glass plate 3 is pressing the aerographite plate 4 while the front one doesn't coincide with the aerographite plate 4. In this manner, the aerographite plate 4 is functioning with its absorption capacity to purify indoor air, especially for newly decorated houses. When it is necessary to open the window, slide the aerographite plate 4 to the other side, as a consequence, the front glass plate will be pressing the aerographite plate 4, thereafter, move the front glass plate to the other end to have the 2 glass plate coincide and open the window, in this way, air entering house will pass the aerographite plate 4, and water and contaminants therein will be absorbed, promising good quality of passing air. After a period of absorption and air purification, turn the glass plate with the glass plate turning motor 11 to a certain degree, slide the front glass plate to press the front side of the aerographite plate 4, to squeeze some of the contaminants out, and then slide the rear glass plate to squeeze the rear side, squeezed water with contaminating air and dirts will fall to the bottom grid 8, thereafter, pass to the bottom of the lower mounting slot 1 through the holes on the bottom grid 8, and will be discharged via the drainage opening 14, the process of air purification and aerographite pressing cleaning is completed.

It is to be understood that the term “includes”, “ including” or any other variants thereof is intended to encompass a non-exclusive inclusion, such that a process, method, article, or device that comprises a plurality of elements includes not only those elements. It also includes other elements that are not explicitly listed, or elements that are inherent to such a process, method, item, or device.

The principles and embodiments of the present invention have been described herein with reference to specific examples, and the description of the above examples is only to aid in understanding the method of the present invention and its core idea. The above description is only a preferred embodiment of the present invention, and it should be noted that due to the finiteness of the textual expression, there is an infinitely specific structure objectively, and those skilled in the art can not deviate from the principle of the present invention. In the following, several modifications, retouchings or variations may be made, and the above technical features may be combined in an appropriate manner; these improvements, retouching, variation or combination, or unmodified, directly apply the inventive concept and technical solution to other occasions. All should be regarded as the scope of protection of the present invention.

What is claimed is:

1. A window capable of mosquito-proof and air purification, comprising mounting slots (1) and side plates (2) embedded in the wall; wherein two horizontally movable mounting fixtures (5) are disposed in the middle of each of the upper and lower mounting slots (1), A purification plate is installed between two mounting fixtures (5), and glass plate movable devices are installed between each mounting fixture (5) and the slot wall of the mounting slot (1), A glass plate (3) is installed between the upper and lower glass plate movable devices; the purification plate includes a purification mounting frame (6) installed in between the two mounting fixtures (5), An aerographite plate (4) is installed in the purification installation frame (6), The thickness of the aerographite plate (4) is greater than spacing between outer sides of both mounting fixtures (5), wherein in the side plates, side slots (7) cooperating with the purification mounting frame (6) are provided.

2. The window capable of mosquito-proof and air purification of claim 1, wherein a horizontal bottom grid (8) is set in the lower mounting slot (1), The purification mounting frame (6) and the lower glass plate movable device are mounted on the bottom grid (8), and at the lower side of the rear plate of the lower mounting slot (1) is provided a drainage opening (14).

3. The window capable of mosquito-proof and air purification of claim 1, wherein the glass plate movable device includes a glass plate turning mounting seat (12), which is connected with the glass plate (3) and extends beyond the wall of the mounting slot (1), A glass plate turning motor (11) is disposed under the glass plate turning mounting seat (12), and rolling balls are set under and to the sides of the said glass plate turning motor (11).

4. The window capable of mosquito-proof and air purification of claim 3, wherein the wall of the mounting slot (1) is provided with a soft sealing block (13) cooperating with the glass plate turning mounting seat (12).

5. The window capable of mosquito-proof and air purification of claim 4, wherein the sides of glass plates are of a beveling shape, with the farthest edge flush with the sides of the aerographite plates (4), inclining angle between the beveling sides and straight plane is 5-20 degrees.

6. The window for mosquito-proof and purification of claim 3, wherein both the left side and right side of the glass plate turning motor (11) are connected to the turning motor movable supporting blocks (16) via the turning motor supporting rods (15), To the lower part and the sides of the turning motor movable supporting block (16) are provided rolling balls (10); the upper part of the turning motor movable supporting block (16) works together with the glass plate turning mounting seat (12) by contacts but not connection, And the upper part of the turning motor movable supporting block (16) is a smooth plane.

7. The window capable of mosquito-proof and air purification of claim 1, wherein a mounting frame movable blocks (9) are provided on the upper and lower part of the purification mounting frame (6), The lower part and the side of the mounting frame movable block (9) are provided with rolling balls (10).
